(19) United States
(12) Patent Application Publication
(10) Pub. No.: US 2003/0132644 A1
(43) Pub. Date: Jul. 17, 2003

(54) Extremely low aerodynamic drag trailer

(76) Inventor: William Joseph Crews, Jacksonville, FL (US)

Correspondence Address: William J. Crews, 6241 Kellow Drive, Jacksonville, FL, 32216, US

(21) Appl. No.: 10/043,750

(22) Filed: Jan. 14, 2002

(51) Int. Cl. B62D 35/00; B60D 1/00

(52) U.S. Cl. 296/181; 280/482

(57) ABSTRACT

A trailer (1) that takes the general cross sectional shape of the towing vehicle (10) to rid the tow vehicle of a large fuel consuming drag force that normally exists behind the towing vehicle. A cowling (2) that enables this averaged shaped cross section to match to a variety of towing vehicles with similar shapes. A gradually tapering rear section of the same trailer that significantly reduces drag. A trailer tongue (3) that will adjust longer for maneuverability or shorter for less aerodynamic drag. A door (5) that will automatically deploy in an instant.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISK APPENDIX

NOT APPLICABLE

### BACKGROUND OF THE INVENTION

This invention relates to and vastly improves the aerodynamic qualities of a transportable hauling container, such as a camper or utility trailer.

Much of the previous development in the area of aerodynamics of camper and utility trailers has been to modify the front of the trailer, or towed vehicle to deflect or pierce the air, or change the cross sectional area of the trailer. AERODYNAMIC DRAG IS DIRECTLY PROPORTIONAL TO Cd (aerodynamic drag coefficient) and CROSS SECTIONAL AREA. Some campers use an area reduction technique colloquially called a pop-up or crank up. While this may have reduced the overall aerodynamic drag of the trailer, it did little to modify the aerodynamics of the towing vehicle as well as the towed vehicle.

A towing vehicle has a low-pressure area associated with the rear of the vehicle. This low pressure has the effect of pulling the vehicle backwards. To overcome this pulling effect, power from the engine, with accompanying extra fuel, is required. This low pressure can be greatly reduced if the towed vehicle is an extension of the towing vehicle. This is accomplished to some degree on tractor-trailer combinations but is inadequate to fully realize the potential and is totally absent in the camper/utility trailer industry.

One of the problems in making the towed vehicle an extension of the towing vehicle is the large air gap between the two. This air gap is required for slow speed maneuvering and for backing the trailer. These maneuvers are needed less than one percent of the time a trailer is in use and the rest of the time the towing vehicle is paying a heavy price for this convenience with higher fuel consumption and added wear on the power train. Some prior art exists to help with this problem in the tractor-trailer industry by using deflectors or diaphragms and such but these prove to be cumbersome to install, interfering with operation and as such are inadequate.

It has been observed that at high speeds the distance required for maneuvering a vehicle combination is small. A few inches are sufficient. The rest of the time the trailer tongue or the distance between the towing and towed vehicle is larger than needed.

The above observations were born out by extensive wind tunnel testing using many model combinations. The result is an existing 1250-lb prototype trailer plus a 3640-lb towing vehicle that gets better fuel economy at high speeds than the towing vehicle gets by itself without the trailer. This was verified by two methods, which include coast down data and fuel flow meter data.

Coast down data is a way of determining how much resisting force is on the vehicle. The resisting force is made up of aerodynamic drag and wheel drag. For the limited speed range that we are interested in, wheel drag force is approximately a constant. A simplified version of the equation for total drag on the vehicle can be approximated by Newton's Law that states that Force=Mass×Acceleration. The actual equation used incorporated wheel drag too, but it is not necessary to understand the technique. The vehicles were measured at a calibrated weigh station to determine their masses. Their acceleration was measured by using a stopwatch to time how long it takes to coast from 75 to 70 mph (for example) and dividing it by the elapsed time. If you then take the quotient for the two different configurations and allow for the different masses and tire drag you will get the percentage change in the aerodynamic force of the two configurations. At high speeds, approximately 70 mph, the trailer drag zeros out. That is to say that it takes no more energy to pull the trailer at this speed than it does to drive the towing vehicle alone. The corollary is that at speeds higher than this, it saves fuel pulling the trailer over driving the towing vehicle alone.

This was observed in the wind tunnel also, but further corroboration was desired. A fuel meter was then installed in the towing vehicle and the same results were indicated. These results offer positive proof that the towing vehicles aerodynamic qualities were altered in a major positive way. At low speeds or with very heavy vehicles, wheel and tire drag represent a larger percentage of total drag and does not provide as much room for aerodynamic improvement.

My invention addresses and modifies both critical components of aerodynamic drag and dramatically improves the present state of the art for coupled towing vehicles plus trailer combinations. My invention contains a trailer tongue that is adjustable. A moveable trailer tongue does show up in examination of the prior art, however, prior art uses the adjustment for totally different purposes. Typically, this adjustment is used to help hook up the trailer when one is alone or to get the trailer down further in the water for launching a boat. No prior art was found to adjust the tongue length for aerodynamic purposes.

### SUMMARY

This invention dramatically reduces the drag on a towing plus towed vehicle combination. This directly influences in a positive way power requirements, fuel economy and handling characteristics of the vehicles. Since the shape of this invention could be somewhat difficult to enter, the invention further offers solutions to this potential problem.

### OBJECTS AND ADVANTAGES

Accordingly, several objects and advantages of my invention are:

A shape of the towed vehicle that modifies the aerodynamic properties of the towing vehicle dramatically and positively.

A shape that when coupled to the towing vehicle is far more aerodynamic than the current state of the art.

A means for dynamically coupling the two vehicles that decreases the distance between them at highway speeds to a more aerodynamic configuration and increases that distance at maneuvering speeds.

A means for easily entering and exiting an otherwise somewhat difficult to access form.

A fill-size latching door that stows with no effort (no zippers, snaps or cumbersome connectors).

Further objects and advantages of my invention will become apparent from a consideration of the drawings and ensuing description.

### DRAWING FIGURES

FIG. 21 shows a towing vehicle (10), the trailer body (1), the cowling (2) on the front of the trailer body, the cowling and the trailer body in the position for high-speed use (2a), and the adjustable trailer tongue (3)

FIG. 22 shows the 3 angles that taper the rear of the trailer. Angle A is the approximate slope that the top makes with a horizontal/longitudinal plane. Angle B is the approximate slope that the bottom rear makes with a horizontal/longitudinal plane. Angle C is the approximate angle that the rear sides make with a vertical/longitudinal plane coincident to the flat portion of the side of the vehicle.

FIG. 23 shows the trailer (1) in a camper configuration with the top (4) up, the ramp (3) down and the door (5) rotated up into position.

FIG. 24 shows the rear of the trailer closed and ready for travel.

FIG. 25 Shows the camper configuration door (5) in the intermediate position between stored and in place. The cut away section of the trailer body allows the hinges (7) at the base of the door to be seen. Rollers (6) are attached to the top of the door and roll in two tracks (8) attached to the top (4) of the trailer.

FIG. 26 shows an alternate configuration of the top (4a) hinged on the side (9) being towed by vehicle (10). Arrows point in the direction that the two half tops would rotate up and out. A cowling patch (12) covers remainder of opening not closed by adjustable cowling.

FIG. 27 shows an alternate configuration of the door (5a) hinged at the floor (7), the top (7b) and an intermediate point (7a).

FIG. 28 shows an alternate embodiment of the trailer without the upward taper.

FIG. 29 shows an alternate embodiment of the trailer without the side tapers.

FIG. 30 shows the trailer closed and ready for travel

FIG. 31 shows the trailer open in the camper configuration ready for use

FIG. 32 shows a plan view of the trailer tongue. The sliding part (3e) and external stationary (relative to the trailer) part (3c) are sectioned to expose the internal screw mechanism. The tongue is approximately halfway extended and its position can be altered by motor (3b) or manual crank (3d).

### REFERENCE NUMERALS IN DRAWINGS

1 Main body of trailer

2 Front cowling

2a Front cowling in the tongue contracted, body forward position

3 Adjustable trailer tongue

3a Screw for adjusting tongue length

3b Reversible Motor for turning screw

3c External Stationary sleeve that houses screw and sliding tongue

3d Handcrank

3e Sliding tongue

3f Gears or sprocket/chain set

4 Top of the trailer

4a Alternate top of the trailer

5 Door of the trailer

5a Alternate door hinged without rollers

6 Door rollers

7 Door hinges at one end

7a Door hinges at intermediate point

7b Door hinges at opposite end

8 Roller tracks

9 Longitudinal hinge for alternate top embodiment

10 Towing vehicle

11 Ramp

12 Cowling patch

Description—Preferred Embodiment

Many passenger vehicles such as vans, suburban utility vehicles and light trucks have very similar cross sections. This is due to ergonomic requirements such as headroom, shoulder-room, road-clearance, etc. . . . Building a trailer that closely matches the average target vehicle in cross section eliminates the extra cross sectional area that many trailers have. This by itself helps improve drag characteristics but it is also helpful to improve on Cd (aerodynamic drag coefficient or slipperiness of the vehicle).

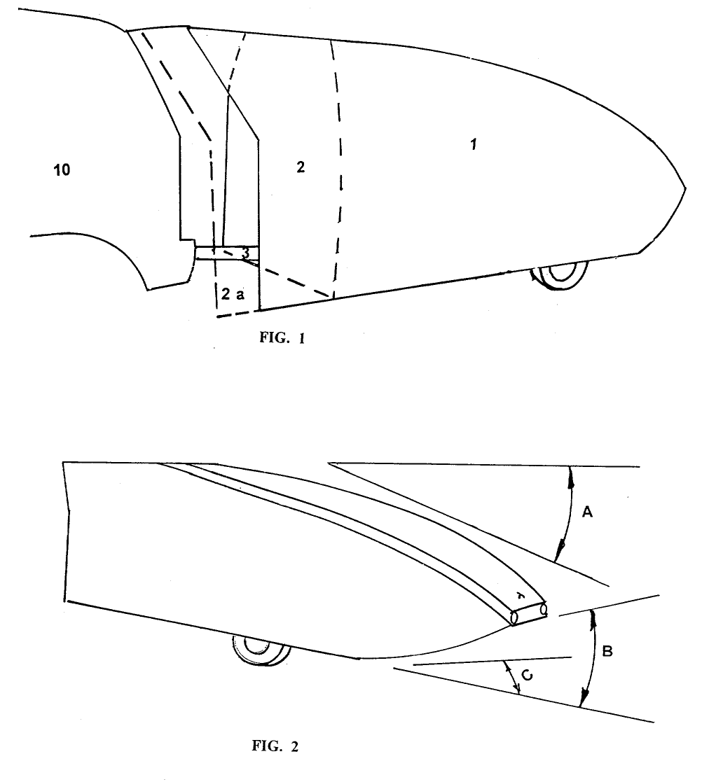

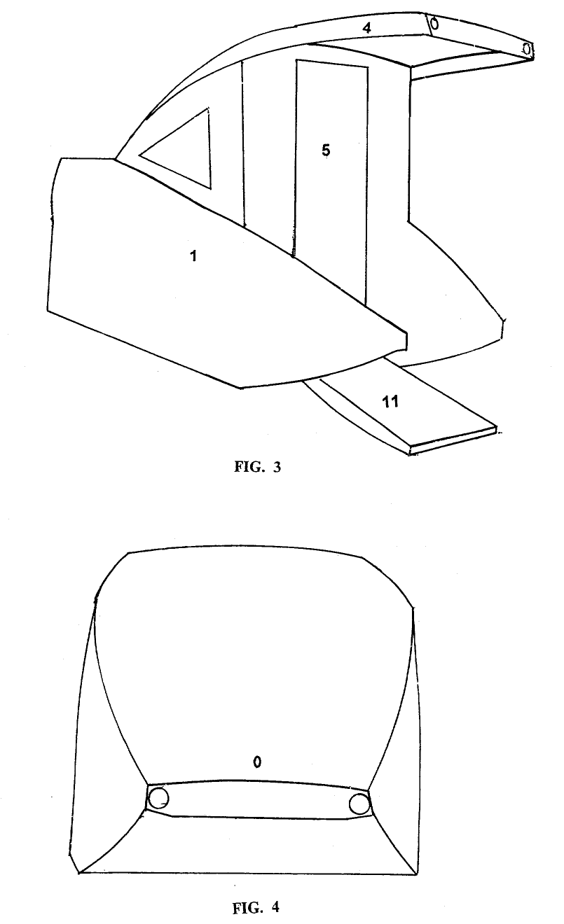

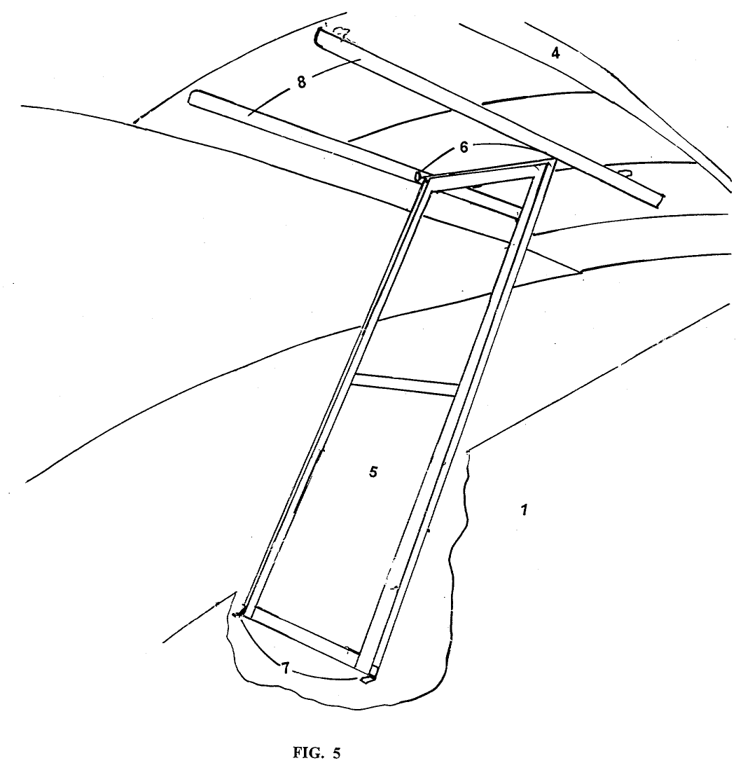

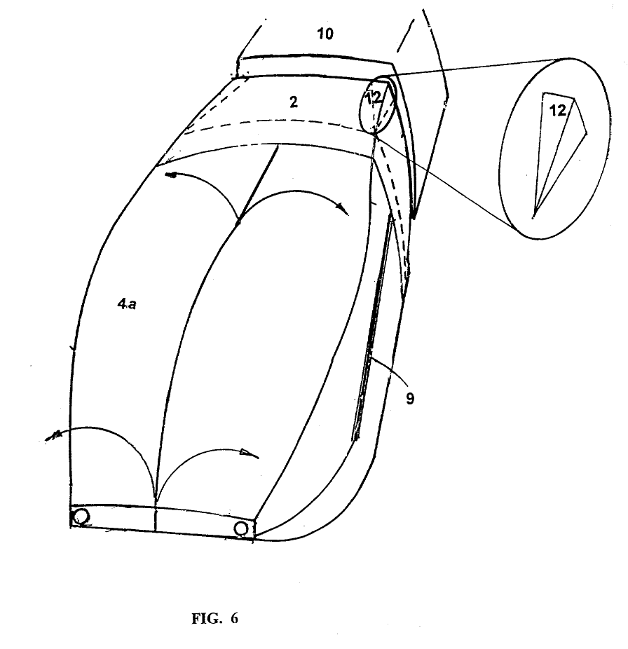

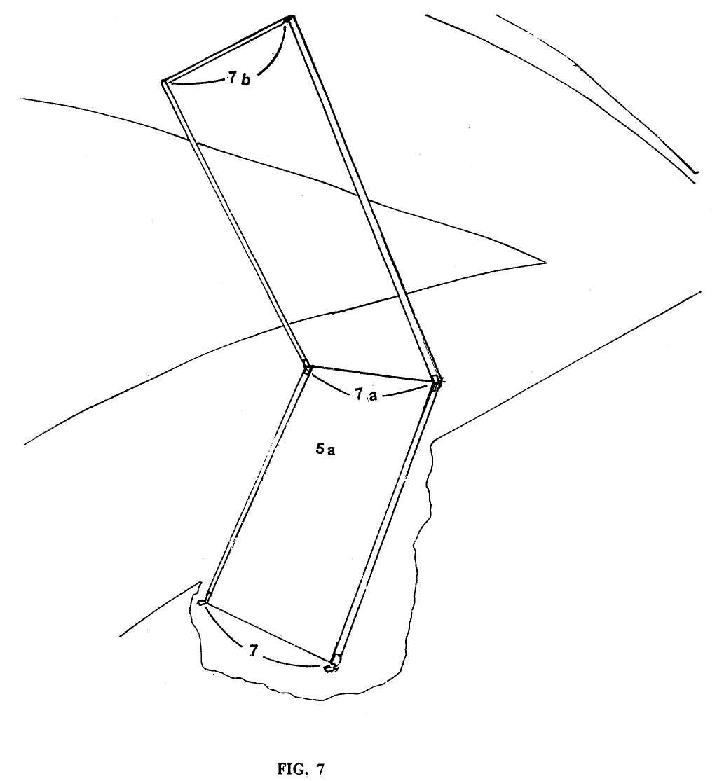

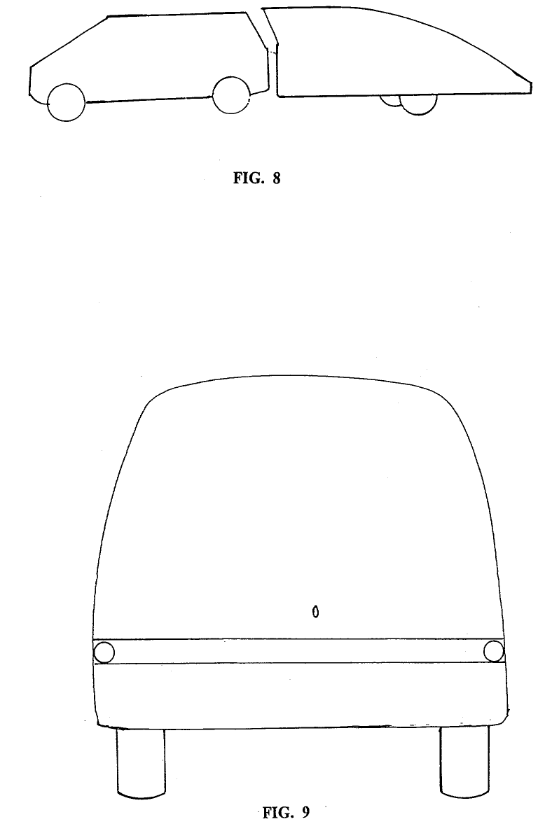

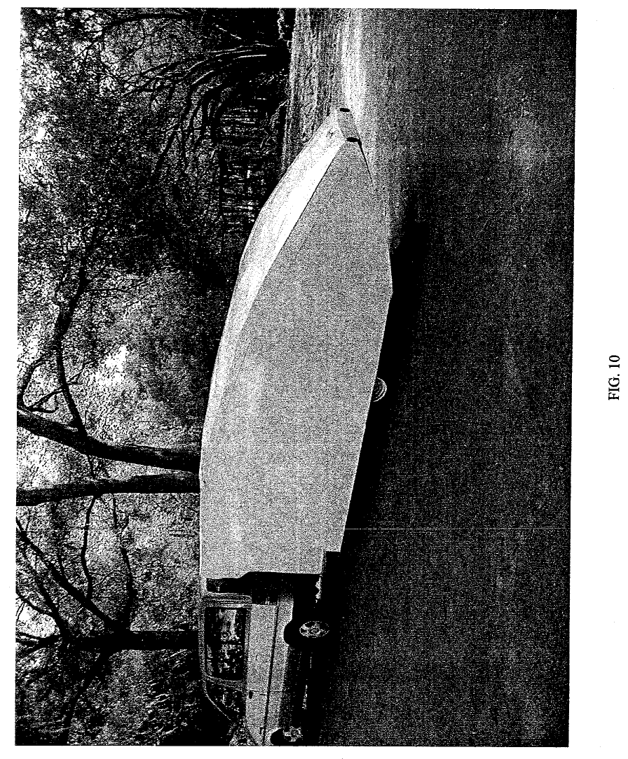

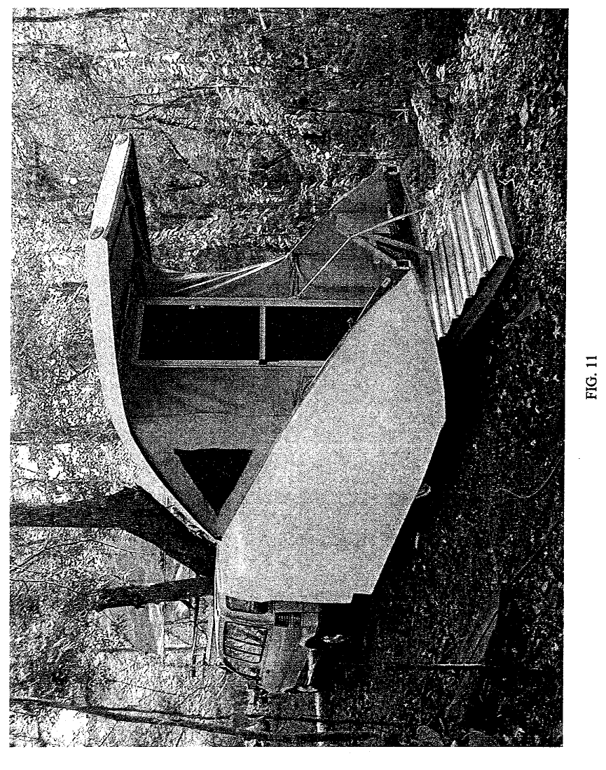

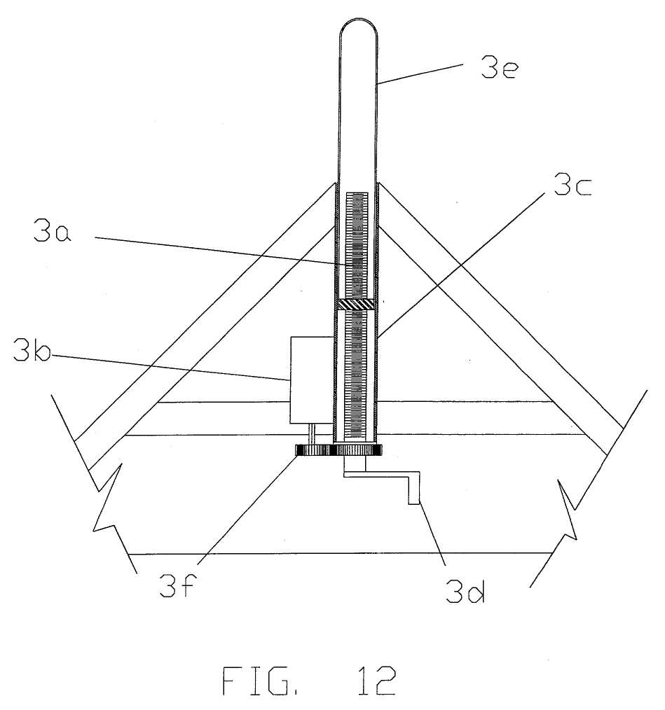

To accomplish this, it is helpful to modify the volume of air between the two vehicles and the air rolling off the rear of the towed vehicle. To deal with the air between the towing vehicle and the trailer, two apparatuses are helpful, either of which by themselves, dramatically help reduce drag. The first is a cowling (2) (FIG. 21 and FIG. 26) that adjusts the averaged trailer cross-section and the distance between the two bodies to the towing vehicle. A cowling patch (12) is fabricated to accommodate different height and width towing vehicles.

The second is an adjustable tongue (3) (FIG. 21). This tongue closes the gap when the vehicles are at highway speeds and opens the gap for slow speed maneuvers. To deal with the air rolling off the rear of the trailer, thus reducing the effects of the low pressure that previously was induced by the towing vehicle, it is necessary to slowly reduce the cross section of the trailers rear portion.

The preferred embodiment uses gently sloping surfaces in the form of arcs. The top (4) sloped down (A) approximately 15 degrees measured from the horizontal. The bottom (3) slopes up (B) approximately 19 degrees measured from the horizontal. The sides slope in (C) approximately 12 degrees from the vertical. This gentle sloping helps reduce turbulence and the accompanying low-pressure drag.

The gentle sloping of the top can be a disadvantage in loading or entering the trailer, due to its low headroom. To get past this disadvantage, the top is hinged towards the front or higher part of the trailer. Due to its size this makes the top somewhat heavy and cumbersome to operate. This can be easily overcome by spring cylinders, counterweights or a door that is spring loaded beneath the top and that rides in a track under the top. In the preferred embodiment, this door acts as a prop for the weighty top. The door (5) is attached in four places, one hinge (7) at the bottom of each vertical jamb and one roller (6) at the top of each of the same. The bottom rear of the trailer (3) latches in the up position for travel and becomes a ramp for loading when in the down position. It is also spring loaded for easy movement.

Operation

With the tongue (3) fully extended the trailer has the necessary clearance to prevent interference between the towing and towed vehicle at maneuvering speeds. As the vehicle gets up to highway speeds the trailer tongue contracts, closing the air gap between the two vehicles. On the prototype vehicle, this is accomplished with a motor driven screw that is operated from the towing vehicle. Controls can be manually operated from the driver's seat or the front of the trailer.

The cowling (2) between the two vehicles is adjusted one time to fit the towing vehicle and remains in that position for the life of the coupling between the two vehicles. This cowling may also be manufactured to fit different vehicles in lieu of making it adjustable. When the vehicle is stopped and ready for loading, the top (4) can be easily pushed upward and the door (5) operates as a prop and spring to easily lift and hold the door in the up or top open position. The bottom or ramp (11) is counterbalanced by an air spring and is let down to form a ramp making access easy for loading dollies or wheeled vehicles. This also makes the trailer “handicap-friendly”.

Description and Operation—Alternative Embodiments

1. The original embodiment had no tongue adjustment but still proved remarkable aerodynamic results. The main draw back was in maneuvering and backing into tight camping sites. In the interest of simplicity, a viable alternative is to completely eliminate the tongue mechanism and forgo some maneuverability and aerodynamic drag.

2. In place of the mechanical motor driven screw for the tongue, a hydraulic, pneumatic or other mechanism could be substituted. This mechanism could be locally or remotely controlled. This mechanism could be controlled automatically receiving feed back from the vehicle speed or other input. A magnetic pickup on the drive shaft is a typical means that is presently used for speed input. A proximity device could be placed between the two vehicles outer radii to monitor the air gap. This devise is used primarily for safety of operation in the event of improper or errant feed back control.

3. As a utility trailer it is an option to reduce or eliminate the rear inward slopes of the sides to allow easier access for wider loading vehicles. As seen through wind tunnel tests, this configuration still maintains excellent aerodynamic drag qualities.

4. The door in the camper version may be totally eliminated for the utility version of this trailer. The doors' function was not only for privacy and to keep the bugs out, but also acts as the opening and supporting device for the top. A spring-loaded device mounted in the center, or one on each side would serve a similar purpose.

5. The door could also be hinged centrally instead of on rollers, or the roller track could be in the floor instead of in the top.

6. The width and height (cross section) of the trailer is somewhat limited by the size (not power) of the towing vehicle. This is only a limit in the towed configuration. There is no reason that the trailer could not fold out or up to create more interior volume while not being towed.

### CONCLUSION, RAMIFICATIONS, AND SCOPE

From the description above, a number of advantages become evident.

(a) The longer man is on this earth, the more depleted the oil reserves become, and thus the more expensive it will be to travel down our highways. This trailer is a large step in the right direction for reducing these oil requirements and their related expenses.

(b) With the reduced drag, a corresponding reduction in power is advantaged. This power reduction has the effect of lowering emissions, requiring a smaller engine to do the same job (with accompanying reduced weight advantages) or letting the present power train not work as hard thus increasing the life expectancy of the power train.

(c) At high speeds, speeds up to 85 mph, while passing or being passed by tractor-trailers, this trailer handles remarkably well. Due to safety considerations speeds higher than 85 mph have not been tested. Observations show little or no more wind buffeting in combination than the towing vehicle has by itself.

(d) With the increase in pressure behind the coupled vehicles, there should be less rain and debris drawn up from the road. This has not been quantitatively measured yet, but qualitatively it appears to be an improvement. This could result in a corresponding reduction in the risk of accidents.

(e) As a camper trailer the top is a breeze to operate taking just a few seconds to convert from the closed and locked position, to the open and ready to access position. Eliminating the door, with a properly counter balanced top, this trailer would also become easy to access as a utility trailer.

(f) The ramp that acts in the positive for aerodynamics ancillary becomes a major benefit to the handicapped or the person trying to load a wheeled vehicle or apparatus.

In summary, the present invention is user friendly and remarkably energy efficient. The invention has been described herein in terms of several preferred embodiments. Other embodiments of the invention, including alternatives, modifications, permutations and equivalents described herein, will be apparent to those skilled in the art, after review of the specifications, study of the drawings, and practice of the invention.

For example, while the method has been described to have the top of the trailer swing up hinged from the front, the top could have been folded out laterally and thus allow unlimited vertical loading access and better lighting in daylight hours while still maintaining the aerodynamic form. The trailer currently attracts so much attention that it could easily have an added use as a billboard for advertisement. The embodiments and preferred features described above should be considered exemplary, with the invention being defined by the appended claims. This includes all such alternatives, modifications, permutations and equivalents that fall within the true spirit and scope of the present invention.

1) In combination a towing vehicle and a towed vehicle and a means for changing the distance between them while the vehicles are at rest or in motion whereby the towing and towed vehicle can improve their aerodynamic qualities.

2) A mechanism used in claim one that is operated locally, remotely, automatically or manually.

3) A trailer whose forward cross section substantially matches the cross section of the towing vehicle, and gradually tapers to a very much reduced cross sectional area at the rear.

4) The trailer in claim 3 that reduces in cross section about a horizontal/lateral axis.

5) The trailer in claim 3 that reduces in cross section about a vertical/centerline and horizontal/lateral axis.

6) The trailer in claim 3 whose rear lower aerodynamic surface can be changed from an aerodynamic surface to a loading ramp when needed.

7) The trailer in claim 3 whose top is hinged towards the front part of the trailer and opens from the back whereby large easy access is available.

8) The trailer in claim 3 whose top hinges on one side or both, whereby large easy access is available.

9) The trailer in claim 3 that has a fairing that matches cross section of the front of the trailer at one end and the rear of the towing vehicle at the other and attaches to one or the other.

10) The trailer in claim 3 that has a fairing that is manufactured to fit the front of the trailer at one end and is adjustable to match the cross section of the towing vehicle at the other.

11) A door that will automatically deploy from the stored position to its ready to use position.

12) The door of claim 11 that is full length and non-folding.

13) The door of claim 11 that will fold for storage.

14) The door of claim 11 that will act as a prop to support a top when the top is in the open position.

15) The door of claim 11 that is used for convertible or pop-up campers.
